(19) United States
(12) Patent Application Publication
(10) Pub. No.: US 2026/0093238 A1
(43) Pub. Date: Apr. 2, 2026

(54) TASK ANALYSIS APPARATUS AND TASK ANALYSIS METHOD

(71) Applicant: CANON KABUSHIKI KAISHA, Tokyo (JP)

(72) Inventor: Yuki KANAI, Tokyo (JP)

(21) Appl. No.: 19/330,826

(22) Filed: Sep. 17, 2025

(30) Foreign Application Priority Data
Sep. 27, 2024 (JP) 2024-169200

(51) Int. Cl. G05B 19/4155

(52) U.S. Cl. CPC G05B 19/4155; G05B 2219/32009

(57) ABSTRACT

A task analysis apparatus that determines whether tasks have been performed in a predetermined task process. The task analysis apparatus sets, in an image in which a task state has been captured, a plurality of task regions for which task analysis is to be performed, sets, for the plurality of task regions, an order in which tasks are to be performed, detects an object in the image, and in response to the object being detected in a predetermined task region, determines that a task has been started in the predetermined task region, and in response to the object being detected in a task region that is next in order after the predetermined task region, determines that the task has ended in the predetermined task region.

### BACKGROUND

### Field of the Technology

The present disclosure relates to a system for determining whether tasks have been performed in a predetermined task process.

### Description of the Related Art

Conventionally, at manufacturing sites and the like, there are task processes in which assembly tasks are performed using predetermined tools and in a predetermined order. In such task processes, the overall task time and task time for each task are often predetermined, and a determination is made as to whether the task has ended within the task time, and the worker is notified of the determination result.

However, it is burdensome for a person to constantly confirm whether a task process is being performed in a predetermined task order and within a predetermined task time. Therefore, it is determined whether the task process is being performed within the predetermined task time by analyzing images obtained by capturing the task state.

Japanese Patent Laid-Open No. 2022-180238 discloses a method of detecting a worker from an image obtained by capturing images of a plurality of task regions, determining which task region the detected worker is in, and measuring the task time for each task region based on the time in which the worker is present in each respective task region.

According to Japanese Patent Laid-Open No. 2022-180238, for each task region among a plurality of task regions, it is determined that the task has been started when the worker is detected, and that the task has ended when the worker is no longer detected in the same task region.

However, in Japanese Patent Laid-Open No. 2022-180238, when the worker is repeatedly detected and undetected in a given task region, it is difficult to determine that the task has ended in that task region.

### SUMMARY

The present disclosure has been made in consideration of the aforementioned problems, and provides technical advantages by making it possible to easily determine that a task has ended, even when an object is repeatedly detected and undetected in a given task region.

In order to solve the aforementioned problems, the present disclosure is directed to a task analysis apparatus that determines whether tasks have been performed in a predetermined task process, the apparatus comprising: a region setting unit that sets, in an image in which a task state has been captured, a plurality of task regions for which task analysis is to be performed; an order setting unit that sets, for the plurality of task regions, an order in which tasks are to be performed; an object detection unit that detects an object in the image; and a determination unit that in response to the object being detected in a predetermined task region, determines that a task has been started in the predetermined task region, and in response to the object being detected in a task region that is next in order after the predetermined task region, determines that the task has ended in the predetermined task region.

In order to solve the aforementioned problems, the present disclosure is directed to a task analysis method of determining whether tasks have been performed in a predetermined task process, the method comprising: setting, in an image in which a task state has been captured, a plurality of task regions for which task analysis is to be performed; setting, for the plurality of task regions, an order in which tasks are to be performed; detecting an object in the image; in response to the object being detected in a predetermined task region, determining that a task has been started in the predetermined task region, and in response to the object being detected in a task region that is next in order after the predetermined task region, determining that the task has ended in the predetermined task region.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a hardware configuration of a system according to a first embodiment.

FIG. 2 is a block diagram illustrating a configuration of a task analysis apparatus that realizes functions of the system according to the first embodiment.

FIG. 3 is a diagram illustrating a use case according to the first embodiment.

FIG. 4 is a diagram illustrating an application screen of the system according to the first embodiment.

FIG. 5 is a diagram illustrating a setting screen of the system according to the first embodiment.

FIG. 6 is a flowchart illustrating control processing of the system according to the first embodiment.

FIG. 7 is a flowchart illustrating task order deviation determination processing according to the first embodiment.

FIG. 8 is a flowchart illustrating task end determination processing according to the first embodiment.

FIG. 9 is a flowchart illustrating task start determination processing according to the first embodiment.

FIG. 10 is a diagram illustrating information on a result of determination by the control processing of the system according to the first embodiment.

FIG. 11 is a block diagram illustrating a functional configuration of the system according to a second embodiment.

FIG. 12 is a diagram illustrating a setting screen of the system according to the second embodiment.

FIG. 13 is a flowchart illustrating control processing of the system according to the second embodiment.

FIG. 14 is a block diagram illustrating a functional configuration of the system according to a third embodiment.

FIG. 15 is a flowchart illustrating control processing of the system according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In embodiments, a task analysis system and a task analysis apparatus for capturing an image of a task state at a manufacturing site or the like, and determining the task state by image analysis processing will be described.

In the embodiments, as the task analysis system and the task analysis apparatus, a computer apparatus performs image analysis processing and determines whether task times in task regions and a task process are being adhered to.

The processing of the task analysis system and the task analysis apparatus of the embodiments may be implemented by a single computer apparatus, or may be implemented by distributing respective functions to a plurality of computer apparatuses as necessary. The plurality of computer apparatuses are communicatively connected each other.

The computer apparatus may also take the form of a personal computer (desktop PC or notebook PC), a tablet PC, a smartphone, a cloud computer, or the like.

### First Embodiment

First, a first embodiment will be described.

### <Hardware Configuration>

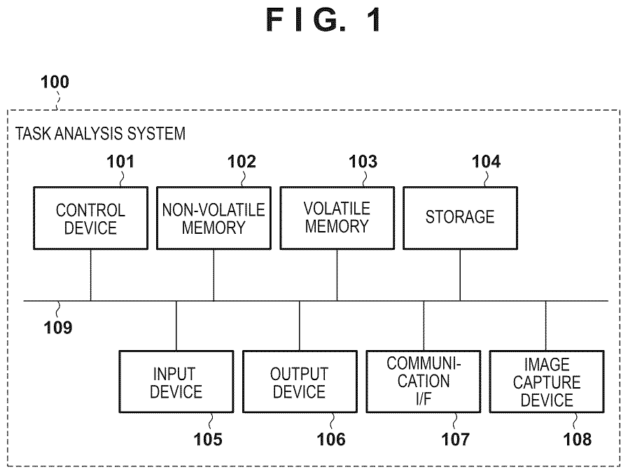

FIG. 1 is a block diagram illustrating a hardware configuration of the task analysis system according to the present embodiment.

The task analysis system (hereinafter, system) 100 of the present embodiment includes a control device 101, a non-volatile memory 102, a volatile memory 103, a storage 104, an input device 105, an output device 106, a communication interface (I/F) 107, an image capture device 108, and a system bus 109.

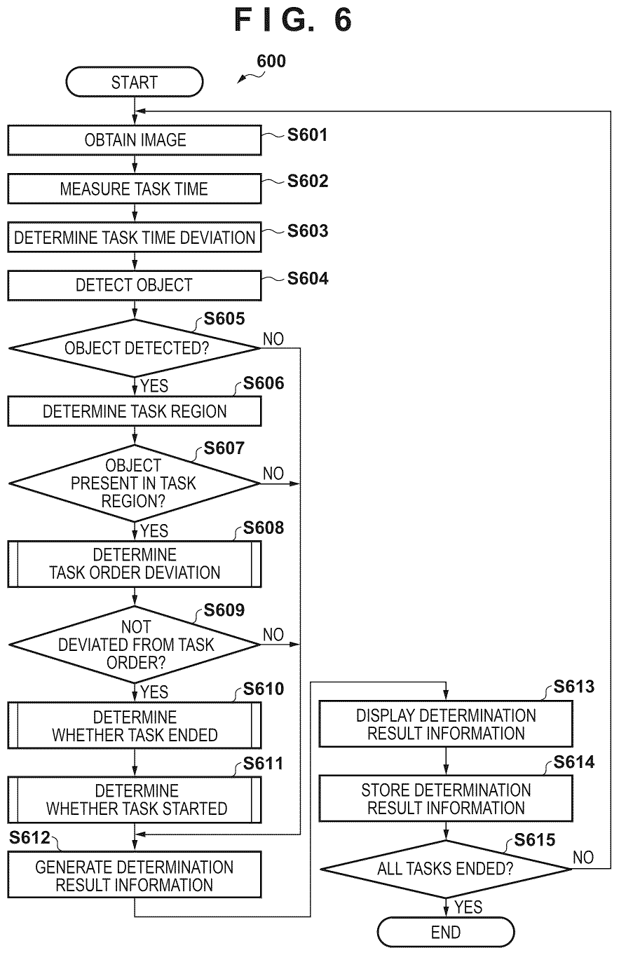

The control device 101 includes a computational processor such as a CPU or an MPU for comprehensively controlling the entire system 100. The non-volatile memory 102 is a program memory such as a ROM for storing a program to be executed by the processor of the control device 101 and parameters. Here, the program is a program for executing control processing, which will be described later in FIGS. 6 to 9, 13, and 15.

The volatile memory 103 is a data memory such as a RAM for temporarily storing programs read from the non-volatile memory 102, constants and variables for executing programs, and the like. The volatile memory 103 includes a work region for programs for the control device 101, a save region at the time of error processing, a load region for programs, and the like.

The program memory may be implemented by loading programs from an external storage device connected to the system 100 of the present embodiment into the volatile memory 103.

The storage 104 is a memory device, such as a Hard Disk Drive or a Solid State Drive that is incorporated in the system 100 or can be connected to the system 100. The storage 104 can also be implemented as an external storage device constituted by a medium (storage medium) and a media drive capable of accessing the medium, for example. Such a medium includes a flexible disk (FD), a CD-ROM, a DVD, a USB memory, an MO disk, a flash memory, and the like, for example. The external storage device may also be a server apparatus or the like connected via a network.

The program for realizing the control processing (described later in FIGS. 6 to 9, 13, and 15), determination result information generated in the control processing, a learning model and parameters used in the control processing, image data captured by the image capture device 108, and the like are stored in the storage 104. A configuration may be taken so as to allow the training model and the parameters to be obtained from an external apparatus via the communication I/F 107.

The input device 105 is an operation member such as a pointing device (e.g., a mouse or a touch panel), a joystick, or a keyboard for receiving a user operation, and outputs operation instructions to the control device 101.

The output device 106 is a display device such as a display or a monitor constituted by an LCD or an organic EL, and displays Graphical User Interfaces (GUIs) of applications, menu screens, captured images, task region determination results, various operation buttons, and the like.

The communication I/F 107 performs wired or wireless communication with an external apparatus via a network such as the Internet or a Local Area Network (LAN). The system 100 of the present embodiment transmits an image in which the task state has been captured by the image capture device 108 to an external apparatus via the communication I/F 107, receives the result of image analysis executed by the external apparatus, and manages the image analysis result in the external apparatus.

The image capture device 108 is incorporated in the system 100 or can be connected to the system 100, and captures an image of one or more task regions and generates image data for determining the start and end of the task in each respective task region. The image capture device 108 includes, for example, a camera incorporated in or connected to the system 100, a network camera, an industrial camera, and the like.

The system bus 109 includes an address bus, a data bus, and a control bus for connecting each of the components 101 to 108 of the system 100 so as to be capable of exchanging data.

The non-volatile memory 102 stores an operating system (OS) (which is basic software to be executed by the control device 101), programs including applications that cooperate with the OS to realize applied functions, and the like.

The functions of the system 100 of the present embodiment are implemented by software provided by an application. It is assumed that the application includes software for using basic functions of the OS installed in the system 100. The OS of the system 100 may include software for realizing processing in the present embodiment.

### <Functional Configuration>

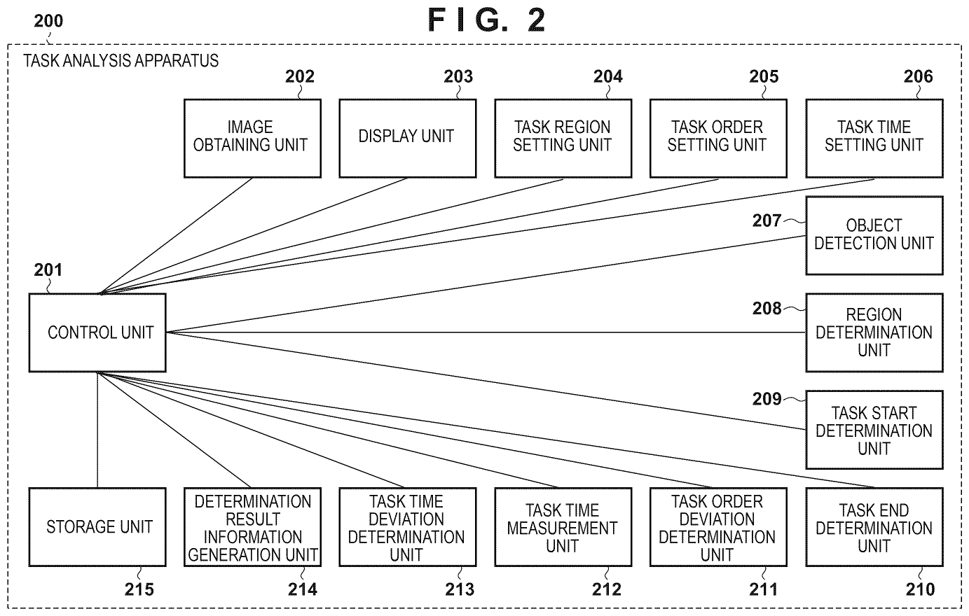

FIG. 2 is a block diagram illustrating a configuration of a task analysis apparatus that realizes functions of the system 100 according to the present embodiment.

A task analysis apparatus 200 of the present embodiment includes a control unit 201, an image obtaining unit 202, a display unit 203, a task region setting unit 204, a task order setting unit 205, a task time setting unit 206, an object detection unit 207, a region determination unit 208, a task start determination unit 209, a task end determination unit 210, a task order deviation determination unit 211, a task time measurement unit 212, a task time deviation determination unit 213, a determination result information generation unit 214, and a storage unit 215.

Each function unit of the task analysis apparatus 200 of the present embodiment is implemented by hardware illustrated in FIG. 1 and/or by the program of the application executed by the control device 101.

The control unit 201 causes the processor of the control device 101 of FIG. 1 to function as the respective function units 202 to 215 of FIG. 2.

The image obtaining unit 202 obtains an image in which the task state is captured from the image capture device 108.

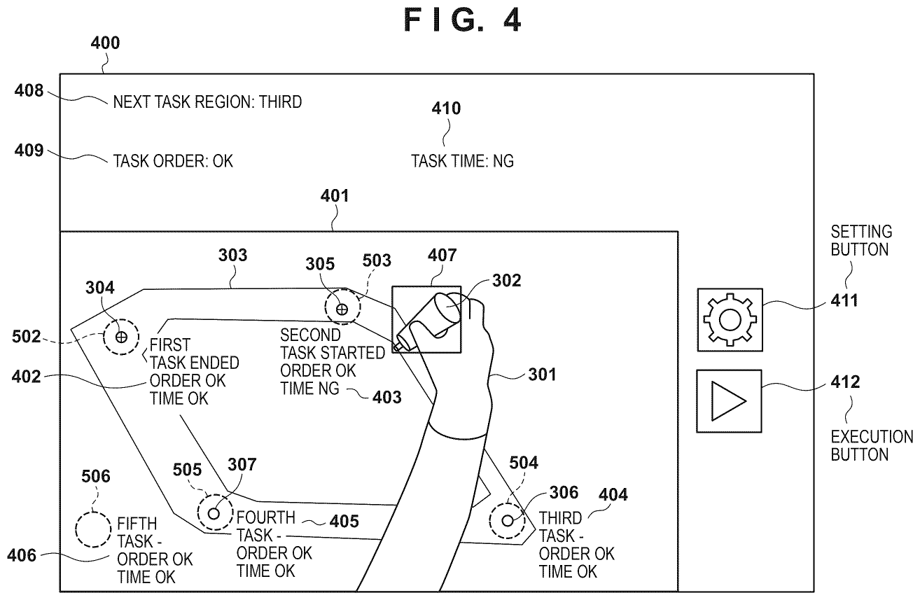

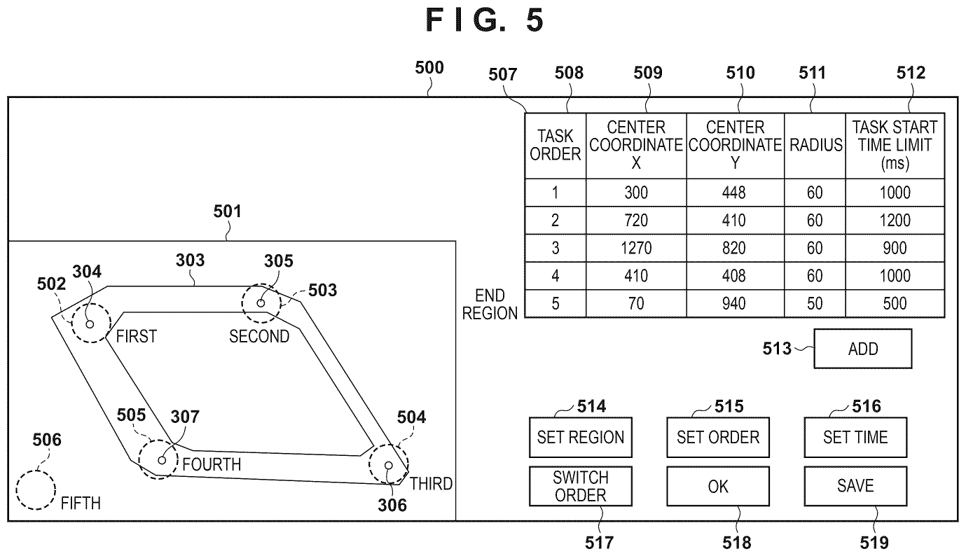

The display unit 203 performs display control of the display device of the output device 106 of FIG. 1. The display unit 203 performs control for displaying a main screen 400 (which will be described later in FIG. 4), a setting screen 500 (which will be described later in FIG. 5), and the like on the display device of the output device 106.

The task region setting unit 204 sets one or more task regions to be subjected to task analysis based on the image obtained by the image obtaining unit 202.

The task order setting unit 205 sets a task order for task regions set by the task region setting unit 204.

The task time setting unit 206 sets a task time for each task region set by the task region setting unit 204 in the order set by the task order setting unit 205.

The object detection unit 207 detects an object in the image and obtains object information (e.g., detected object type and reliability) and coordinate information (e.g., vertex coordinates and center coordinates of a rectangle circumscribing the object in the image). Further, an object detection method of the present embodiment targets, as an object, a tool that can be detected using an object detection model trained in advance to detect a tool from an image, but is not limited to this, and may be any object detection method. For example, a person, a person's hand, or the like may be detected as an object using a detection model trained in advance to detect a person or a person's hand in the image. An object may also be detected by a method that uses feature point matching. Further, a two-dimensional code may be detected as an object by a method that uses two-dimensional bar code detection. An object may also be detected by a method that uses semantic segmentation, which detects the region of each object occupying the image.

The region determination unit 208 determines whether an object has been detected in a task region set by the task region setting unit 204 based on an object detection result of the object detection unit 207.

The task start determination unit 209 determines whether the next task has been started based on a determination result of the region determination unit 208.

The task end determination unit 210 determines whether the current task has ended and whether all tasks have ended based on a determination result of the region determination unit 208.

The task order deviation determination unit 211 determines whether the task order has been deviated from based on a determination result of the region determination unit 208.

The task time measurement unit 212 measures the task time of the current task (time elapsed from the start of the task) for each task region set by the task region setting unit 204.

The task time deviation determination unit 213 determines whether the task time measured by the task time measurement unit 212 is within the time limit set by the task time setting unit 206.

The determination result information generation unit 214 generates determination result information based on various kinds of information stored in the storage unit 215 and results determined by the region determination unit 208, the task start determination unit 209, the task end determination unit 210, the task order deviation determination unit 211, and the task time deviation determination unit 213. The determination result information generation unit 214 also superimposes the determination result information on the image.

The storage unit 215 controls access to at least one of the non-volatile memory 102, the volatile memory 103, and the storage 104 of FIG. 1. The storage unit 215 stores the image, the setting information set by the task region setting unit 204, the task order setting unit 205, and the task time setting unit 206, determination results of the region determination unit 208, the task start determination unit 209, the task end determination unit 210, the task order deviation determination unit 211, and the task time deviation determination unit 213, and the like.

### <Screen Configuration>

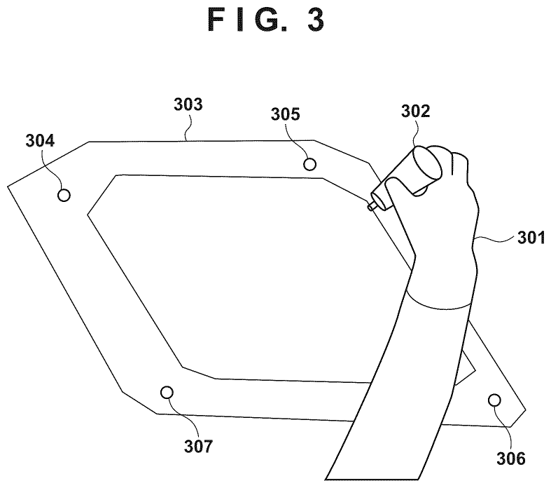

FIG. 3 is a diagram illustrating a use case according to the present embodiment.

In the present embodiment, as illustrated in FIG. 3, a worker 301 holds a tool 302 in their hand and performs a screw tightening task on screw holes 304, 305, 306, and 307 of a task target object 303.

FIG. 4 illustrates the main screen 400 provided by the application of the system 100 according to the present embodiment.

The main screen 400 is displayed by the control unit 201 controlling the display unit 203. A captured image 401, three pieces of information indicating determination results of the task, and two buttons for operating the system 100 are displayed on the main screen 400. Further, the display of the main screen 400 is updated in accordance with control processing 600, which will be described later.

A screen indicating that the worker 301 is holding the tool 302 in their hand and is in the middle of performing a screw tightening operation on the screw holes 304, 305, 306, and 307 of the task target object 303 is displayed on the main screen 400 illustrated in FIG. 4. Further, the worker 301 has ended the task for the screw hole 304, which is the first task, and is working on the screw hole 305, which is the second task. Further, the state is that the task was started within the task start time limit for the screw hole 304, which is the first task, but the task was not started within the task start time limit for the screw hole 305, which is the second task.

Task regions 502, 503, 504, 505, and 506 are displayed in a superimposed manner on the captured image 401 of the main screen 400, based on setting information 507 stored in the storage unit 215, which will be described later. Further, task region determination results 402, 403, 404, 405, and 406 are displayed in a superimposed manner on the captured image 401, based on the determination result information stored in the storage unit 215. Further, a rectangular frame 407 is displayed in a superimposed manner on the captured image 401 so as to surround the tool 302, based on the coordinate information of the tool 302 detected by the object detection unit 207.

The task region determination results 402, 403, 404, 405, and 406 correspond to the task regions 502, 503, 504, 505, and 506, respectively. The determination results of the task start determination unit 209, the task end determination unit 210, the task order deviation determination unit 211 and the task time deviation determination unit 213 for each task region are displayed on the main screen 400.

Information indicating that, for the first task region 502, the task has ended and the task order and the task time have not been deviated from is displayed in the task region determination result 402. Information indicating that, for the second task region 503, the task has started and although the task order has not been deviated from, the task time has been deviated from is displayed in the task region determination result 403. Information indicating that, for the third task region 504, the task has neither started nor ended and the task order and the task time have not been deviated from is displayed in the task region determination result 404. Information indicating that, for the fourth task region 505, the task neither started nor ended and the task order and the task time have not been deviated from is displayed in the task region determination result 405. Information indicating that, for the fifth task region 506, the task neither started nor ended and the task order and the task time have not been deviated from is displayed in the task region determination result 406. The fifth task region 506 is a region provided to determine the end of all tasks, which will be described later. In the fifth task region 506, immediately after it is determined that the task has started, it is determined that the task has ended.

The rectangular frame 407 indicates that the tool 302 has been detected by the object detection unit 207. A next task region 408 indicates the number of the next task to be started in the task order, and information indicating that the third task is to be performed next is displayed. A task order 409 indicates a determination result of whether the task order has been deviated from, up to the current task, and information indicating that the task order has not been deviated from is displayed. A task time 410 indicates a determination result of whether the task time has been deviated from, up to the current task, and information indicating that the task time has been deviated from is displayed.

A setting button 411 is an operation button for displaying the setting screen 500 for setting and storing task region information, task order information, and task time information for performing tasks, which will be described later, by being operated by a user.

An execution button 412 is an operation button for executing the processing of analyzing whether the task in a given task region has ended in accordance with the control processing 600, which will be described later, by being operated by the user.

FIG. 5 is an example of the setting screen 500 displayed by the setting button 411 of FIG. 4 being operated.

The setting screen 500 is displayed by the control unit 201 controlling the display unit 203. The setting screen 500 exemplifies a setting screen related to the task region setting unit 204, the task order setting unit 205, and the task time setting unit 206 of FIG. 2. A captured image 501 captured by the image capture device 108 and stored in the storage unit 215 is displayed on the setting screen 500. The setting screen 500 also includes the setting information 507 (which is a list of set information), an add button 513, a region setting button 514, an order setting button 515, a time setting button 516, an order switch button 517, an OK button 518, and a save button 519.

In the present embodiment, the task region information, the task order information, and the task time information for performing the task are set based on operations of the user, and the setting information 507, which is a list of set information, is stored in the storage unit 215. The captured image 501 includes the screw holes 304, 305, 306, and 307 of the task target object 303. Further, the task region 502, which corresponds to the screw hole 304, is set and displayed on the captured image 501. Further, the task region 503, which corresponds to the screw hole 305, is set and displayed on the captured image 501. Further, the task region 504, which corresponds to the screw hole 306, is set and displayed on the captured image 501. Further, the task region 505, which corresponds to the screw hole 307, is set and displayed on the captured image 501. Further, the task region 506, which corresponds to a task end position, is set and displayed on the captured image 501. The task regions 502, 503, 504, 505, and 506 are generated based on setting values for a task order 508, a center coordinate X 509, a center coordinate Y 510, and a radius 511 of the setting information 507. In addition, only the set records are displayed for the center coordinate X 509, the center coordinate Y 510, the radius 511, the task order 508, and a task start time limit (ms) 512.

The setting information 507 includes the center coordinate X 509, the center coordinate Y 510, and the radius 511 (which are the task region information), the task order 508 (which is the task order information), and the task start time limit (ms) 512 (which is the task time information).

The add button 513 generates a new record in the setting information 507 by being operated by the user. Each field in a newly generated record is empty data.

The region setting button 514 sets the center coordinate X 509, the center coordinate Y 510, and the radius 511 for a record selected in advance in the setting information 507 by being operated by the user. In this case, the center coordinate X 509, the center coordinate Y 510, the radius 511 may be set by values being directly inputted into corresponding fields, or may be set by GUI operations by a mouse or the like on the captured image 501. Region setting ends by the OK button 518 being operated by the user.

The order setting button 515 sets a position of a record, which has been selected in advance in the setting information 507, in the task order 508 by being operated by the user. In this case, a serial number in the task order 508 already set in the setting information 507 is set in a field for the task order 508. Further, the last record in the task order 508 is set as a task end region. Order setting ends by the OK button 518 being operated by the user.

The time setting button 516 sets the task start time limit (ms) 512 for a record selected in advance in the setting information 507 by being operated by the user. In this case, the task start time limit (ms) 512 is set by a value being directly inputted into the field. Further, the task start time limit (ms) 512 to be set is a time limit until it is determined that the task in the corresponding position in the task order 508 started. For example, in the setting information 507 of FIG. 5, a task start time limit (ms) inputted under “1” in the task order is a time limit from the start of the processing 600, which will be described later, to the start of the first task. The task start time limit (ms) inputted under “2” in the task order is a time limit from the start of the first task to the start of the second task. Time setting ends by the OK button 518 being operated by the user.

The order switch button 517 is an operation button for switching the positions of two records, which are selected in advance in the setting information 507, in the task order and displaying the setting information 507 in a manner in which it has been sorted in ascending order of the task order 508 by being operated by the user.

The OK button 518 is an operation button for ending processing for region setting, order setting, and time setting by being operated by the user.

The save button 519 is an operation button for storing the setting information 507 in the storage unit 215 and terminating the processing of the setting screen 500 by being operated by the user.

### <Control Processing>

FIG. 6 is a flowchart illustrating control processing of the system 100 according to the present embodiment.

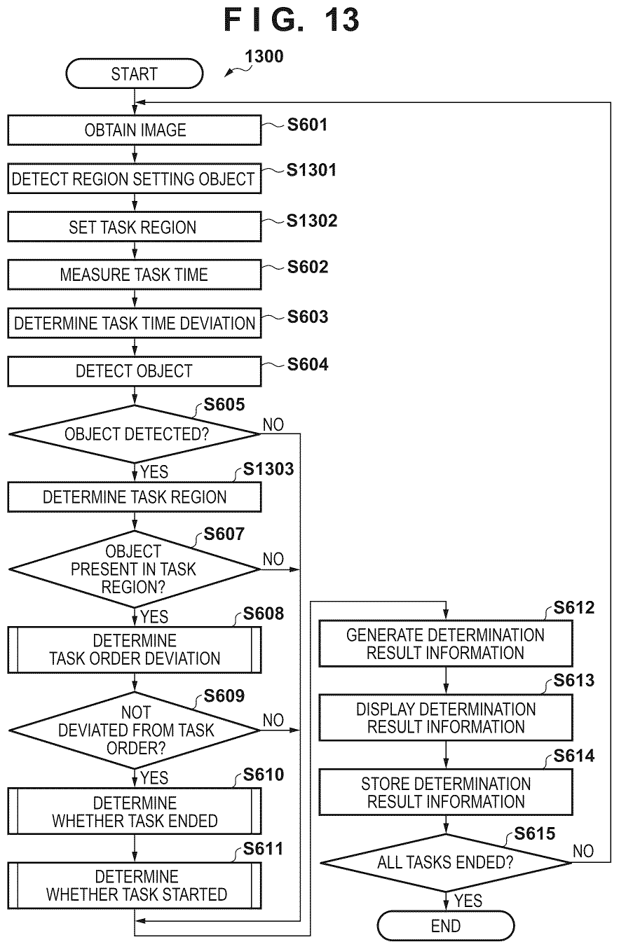

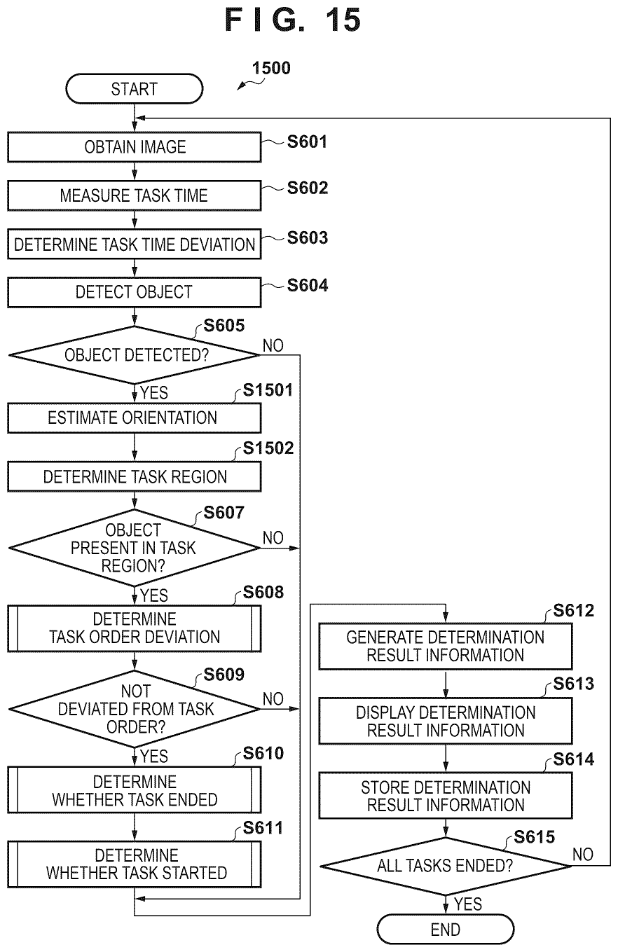

The processing 600 of FIG. 6 is implemented by the control unit 201 illustrated in FIG. 2 controlling the respective function units of FIG. 2 in accordance with the program of the application. Further, the processing 600 of FIG. 6 is started by the user operating the execution button 412 of the main screen 400 of FIG. 4. It is similar for FIGS. 13 and 15, which will be described later.

In step S601, the control unit 201 controls the image obtaining unit 202 to obtain a captured image from the image capture device 108.

In step S602, the control unit 201 controls the task time measurement unit 212 to measure the current time, reference the determination result information stored in the storage unit 215, and calculate a difference (task time) from the time at the start of the task in the task region corresponding to the current position in the task order.

In step S603, the control unit 201 controls the task time deviation determination unit 213 to compare the setting information stored in the storage unit 215 with the task time calculated in step S602 and determine deviation of the task time. The control unit 201 compares the task time calculated in step S602 with the task start time limit (ms) in the setting information corresponding to the current position in the task order. Then, when the task time is less than the task start time limit, the control unit 201 determines that the task time has not been deviated from, and when the task time is greater than or equal to the task start time limit, the control unit 201 determines that the task time has been deviated from.

In step S604, the control unit 201 controls the object detection unit 207 to detect an object in the captured image obtained by step S601 and obtain detected object information, coordinate information, and the like of the object in the image.

In step S605, the control unit 201 determines whether an object has been detected based on the object detection result obtained in step S604. When an object has been detected in step S604, the control unit 201 executes processing of step S606, and when an object has not been detected, the control unit 201 executes processing of step S612.

In step S606, the control unit 201 controls the region determination unit 208 to determine whether an object is present in the task region corresponding to the current position in the task order based on the setting information stored in the storage unit 215 and the coordinate information of the object obtained in step S604. The control unit 201 obtains the determination result and the order value of the determination target task region. The determination as to whether an object is present in the task region in the embodiment is performed by calculating and obtaining the center coordinates from the coordinate information of the object obtained in step S604 and determining whether center coordinate values are within a threshold for each task region set in the setting information. The center coordinates are calculated, for example, as in Equation 1 below.

$$\{ \begin{matrix}an object is present in a task region … {r}_{i} \geq \sqrt{{( X - Cxi )}^{2} + {( Y - Cyi )}^{2}} \\ an object is not present in a task region … {r}_{i} < \sqrt{{( X - Cxi )}^{2} + {( Y - Cyi )}^{2}}\end{matrix} \qquad ( Equation 1 )$$

In Equation 1, X corresponds to the X coordinate of the center coordinates obtained from the coordinate information of the object obtained in step S604, and Y corresponds to the Y coordinate of the center coordinates. Cxi corresponds to the center coordinate X in an i-th position in the task order set in the setting information, Cyi corresponds to the center coordinate Y in the i-th position in the task order, and ri corresponds to the radius in the i-th position in the task order. As in Equation 1, if a distance between the coordinate information of the object and the center coordinates of each respective task region set in the setting information is less than or equal to the radius of the respective task region, it is determined that an object is present in the task region, and if the distance is greater than the radius, it is determined that no object is present. In addition, regarding the order value, if it is determined that an object is present in an i-th task region in the task order, “i”, which is its position in the task order, is obtained, and if it is determined that no object is present in any of the task regions, “0” is obtained. These values are not limited to what is defined here, and may be set to arbitrary values. For example, a configuration may be taken so as to calculate a distance between an arbitrary coordinate value from the coordinate information of the detected object and the center coordinates of each respective task region, and determine whether the object is present in the task region. Further, regarding the object to be determined, a configuration may be taken so as to select an arbitrary object and determine whether it is present in the task region, such as selecting only a detection result with the highest reliability among the detected objects. Further, a configuration may be taken so as to select a plurality of objects and determine whether each is present in the task region.

In step S607, the control unit 201 determines whether it has been determined that an object is present in the task region based on the task region determination result obtained in step S606. When it is determined that an object is present in the task region in step S606, the control unit 201 executes processing of step S608, and when it is not determined that an object is present in the task region, the control unit 201 executes processing of step S612.

In step S608, the control unit 201 controls the task order deviation determination unit 211 to determine whether the task order has not been deviated from based on the determination result information stored in the storage unit 215 and the task region determination result obtained in step S606.

In step S609, the control unit 201 determines whether it has been determined the task order has not been deviated from based on the task order deviation determination result obtained in step S608. When it is determined in step S608 that the task order has not been deviated from, the control unit 201 executes processing of step S610, and when it is not determined that the task order has not been deviated from, the control unit 201 executes processing of step S612.

In step S610, the control unit 201 controls the task end determination unit 210 to determine whether the task has ended based on the setting information stored in the storage unit 215 and the task region determination result determined in step S606.

In step S611, the control unit 201 controls the task start determination unit 209 to determine whether the task has started based on the setting information stored in the storage unit 215 and the task region determination result determined in step S606.

In step S612, the control unit 201 controls the determination result information generation unit 214 to generate determination result information.

In step S613, the control unit 201 controls the display unit 203 to update the display of the main screen 400 based on the determination result information generated in step S612.

In step S614, the control unit 201 controls the storage unit 215 to store the determination result information generated in step S612.

In step S615, the control unit 201 determines whether it has been determined that all tasks have ended based on the task end determination result obtained in step S610. When it is determined in step S610 that all tasks have ended, the processing 600 is ended, and when it is determined that not all the tasks have ended, the processing of step S601 is executed.

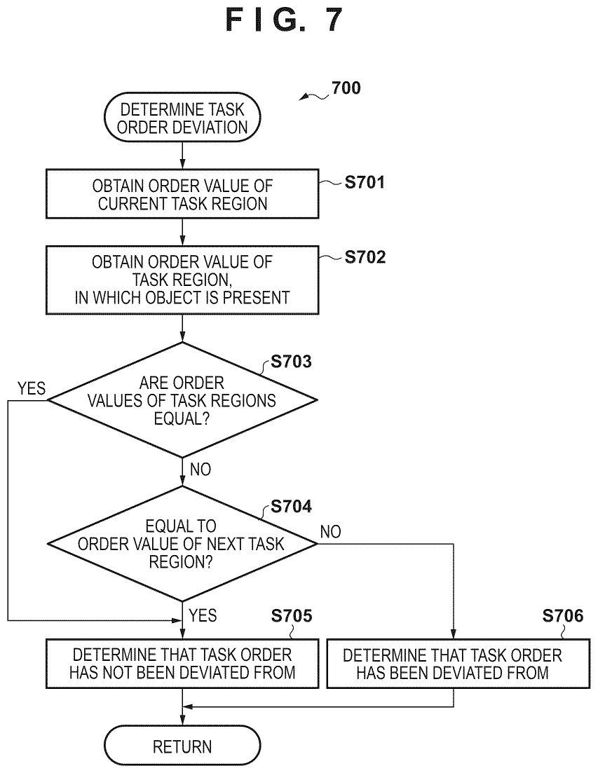

FIG. 7 is a flowchart explaining the task order deviation determination processing in step S608 of FIG. 6.

In step S701, the task order deviation determination unit 211 obtains the order value of the current task region, whose task is “started” in the determination result information stored in the storage unit 215.

In step S702, the task order deviation determination unit 211 obtains the order value of the task regions, for which it has been determined that an object is present in the task region in the region determination result obtained in step S606.

In step S703, the task order deviation determination unit 211 determines whether the order value of the task region obtained in step S702 is equal to the order value the current task region obtained in step S701. When it is determined that the order value of the task region obtained in step S702 is equal to the order value of the current task region obtained in step S701, the task order deviation determination unit 211 executes the processing of step S705, and when it is not determined to be equal, the task order deviation determination unit 211 executes the processing of step S704.

In step S704, the task order deviation determination unit 211 determines whether the order value of the task region obtained in step S702 is the order value of a task region to be worked on next. The task order deviation determination unit 211 determines whether the order value of the task region obtained in step S702 is equal to a value obtained by adding 1 to the order value of the current task region obtained in step S701, for example. Then, when the order value of the task region obtained in step S702 is the order value of a task region worked on next, the task order deviation determination unit 211 executes the processing of step S705, and otherwise, the task order deviation determination unit 211 executes the processing of step S706.

In step S705, the task order deviation determination unit 211 determines the task order has not been deviated from.

In step S706, the task order deviation determination unit 211 determines the task order has been deviated from.

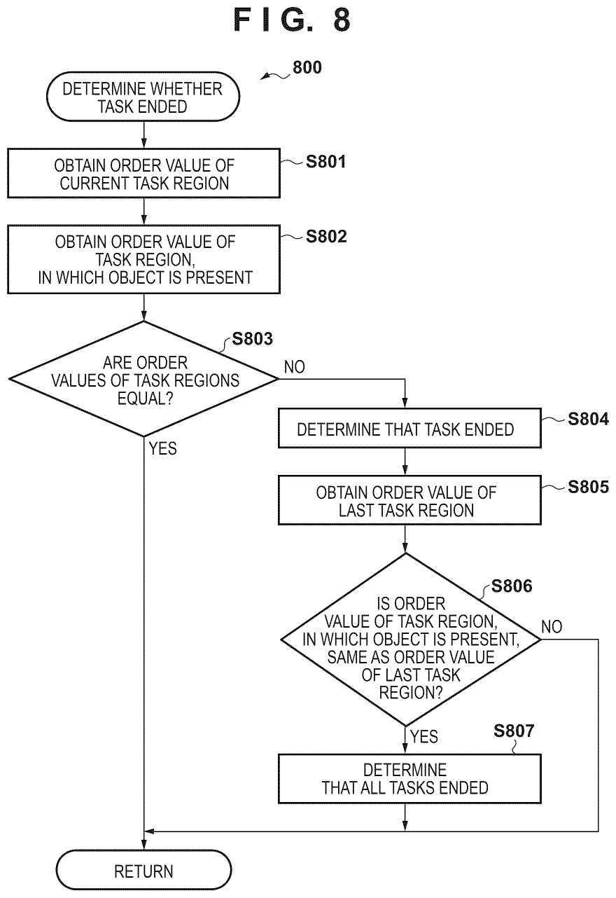

FIG. 8 is a flowchart explaining the task end determination processing in step S610 of FIG. 6.

In step S801, the task end determination unit 210 obtains the order value of the current task region, whose task is “started” in the determination result information stored in the storage unit 215.

In step S802, the task end determination unit 210 obtains the order value of the task regions, for which it has been determined that an object is present in the task region in the region determination result obtained in step S606.

In step S803, the task end determination unit 210 determines whether the order value of the task region obtained in step S802 is equal to the order value of the current task region obtained in step S801. When the order value of the task region obtained in step S802 is equal to the order value of the current task region obtained in step S801, the task end determination unit 210 determines that the current task region is being worked on, and ends processing 800. When the order value of the task region obtained in step S802 is not equal to the order value of the current task region obtained in step S801, the task end determination unit 210 executes processing of step S804.

In step S804, the task end determination unit 210 determines that the task of the current task region obtained in step S801 has ended. In this case, since the object is detected in a task region that is next in the task order after the current task region, it is determined that the task of the current task region has ended.

In step S805, the task end determination unit 210 obtains the order value of the last task region, which is set as the task end region in the setting information stored in the storage unit 215.

In step S806, the task end determination unit 210 determines whether the order value of the task region, for which it is determined that an object is present in the task region, obtained in step S802 is the last task region. The task end determination unit 210 determines whether the order value of the task region, for which it is determined that an object is present in the task region, obtained in step S802 is equal to the order value of the task region, which is the task end region, obtained in step S805. When it is determined that the order value of the task region, in which it is determined that an object is present in the task region, obtained in step S802 is the last task region, the task end determination unit 210 executes the processing of step S807, and when it is not determined to be equal, the task end determination unit 210 ends the processing 800.

In step S807, the task end determination unit 210 determines that all tasks have ended.

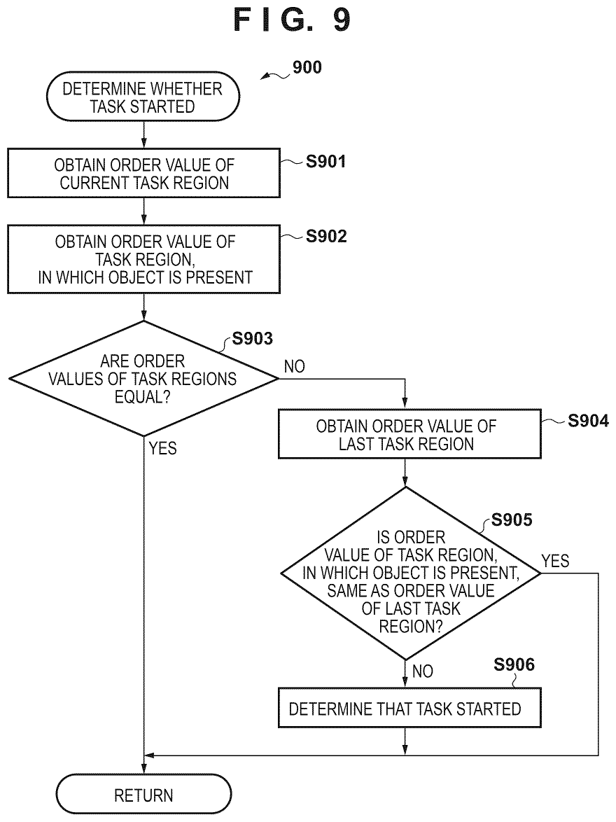

FIG. 9 is a flowchart explaining the task start determination processing in step S611 of FIG. 6.

In step S901, the task start determination unit 209 obtains the order value of the current task region, whose task is “started” in the determination result information stored in the storage unit 215.

In step S902, the task start determination unit 209 obtains the order value of the task regions, for which it has been determined that an object is present in the task region in the region determination result determined in step S606.

In step S903, the task start determination unit 209 determines whether the order value of the task region obtained in step S902 is equal to the order value of the current task region obtained in step S901. When the order value of the task region obtained in step S902 is equal to the order value of the current task region obtained in step S901, the task start determination unit 209 determines that the current task region is being worked on, and ends processing 900. When the order value of the task region obtained in step S902 is not equal to the order value of the current task region obtained in step S901, the task start determination unit 209 executes processing of step S904.

In step S904, the task start determination unit 209 obtains the order value of the last task region, which is set as the task end region in the setting information stored in the storage unit 215.

In step S905, the task start determination unit 209 determines whether the order value of the task region, for which it is determined that an object is present in the task region, obtained in step S902 is the order value of the last task region obtained in step S904. When the order value of the task region, for which it is determined that an object is present in the task region, obtained in step S902 is equal to the order value of the last task region obtained in step S904, the task start determination unit 209 ends the processing 900, and otherwise, the task start determination unit 209 executes processing of step S906.

In step S906, the task start determination unit 209 determines that the task of the task region corresponding to the order value of the task region, for which it is determined that an object is present in the task region, obtained in step S902 has started, and ends the processing 900.

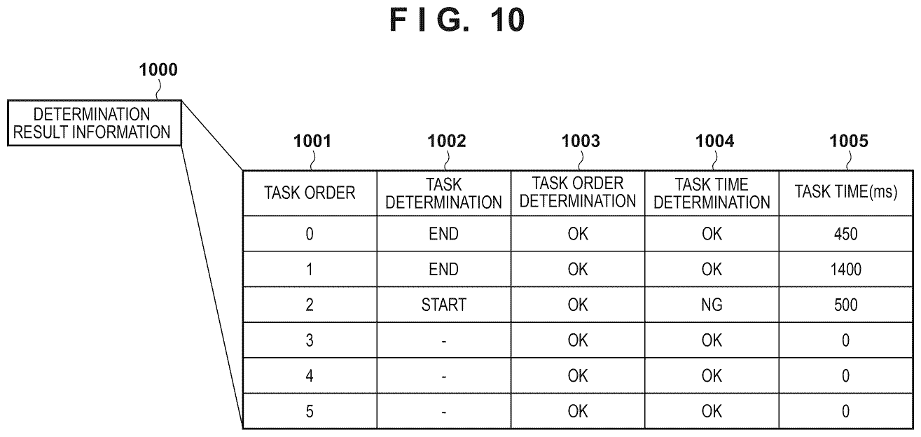

FIG. 10 illustrates determination result information generated in step S612 of FIG. 6.

Determination result information 1000 includes a task order 1001, task determination 1002, task order determination 1003, task time determination 1004, and a task time (ms) 1005.

Regarding the task order 1001, numerical values are stored corresponding to the task order 508 stored in the storage unit 215. Regarding the task determination 1002, results determined by the task start determination unit 209 and the task end determination unit 210 are stored. For example, when it is determined by the task end determination unit 210 that a task has ended in a task region corresponding to a respective position in the task order 1001, “end” is stored in the task determination 1002. When it is determined by the task start determination unit 209 that a task has been started, “start” is stored in the task determination 1002. When neither the end nor the start has been determined, “-” is stored. Regarding the task order determination 1003, results determined by the task order deviation determination unit 211 are stored. For example, when it is determined by the task order deviation determination unit 211 that the task order has been deviated from in a task region corresponding to a respective position in the task order 1001, “NG” is stored in the task order determination 1003. When it is determined by the task order deviation determination unit 211 that the task order has not been deviated from, “OK” is stored in the task order determination 1003. Regarding the task time determination 1004, results determined by the task time deviation determination unit 213 are stored. For example, when it is determined by the task time deviation determination unit 213 that the task time has deviated in a task region corresponding to a respective position in the task order 1001, “NG” is stored in the task time determination 1004. When it is determined by the task time deviation determination unit 213 that the task time has not deviated, “OK” is stored in the task time determination 1004. Regarding the task time (ms) 1005, the time elapsed from the start of the task measured by the task time measurement unit 212 is stored.

As described above, according to the first embodiment, the order value of a task region in which an object is present in the task region is compared with the order value of a predetermined task region in which the task has “started”, and if there is no deviation from the task order and the order values of both task regions are not equal, it means that the object is detected in a task region that is next in the task order after the predetermined task region, and thus, it is determined that the task of the predetermined task region has ended.

In addition, when the order value of the second task region in which an object is present in the task region is equal to the order value of a task region that is last in the task order, it is determined that all tasks have ended.

Thus, it is possible to easily determine that a task has ended even when an object is repeatedly detected and undetected in a given task region.

### Second Embodiment

Next, a second embodiment will be described.

In the following, descriptions in common with the first embodiment will be omitted, and parts different from the first embodiment will be described.

In the first embodiment, a method of region setting by the task region setting unit 204 in which a task region is circular has been described. In the first embodiment, a setting for a task region is only circular, and a setting for an arbitrary polygon such as an elongated task region cannot be performed, and it is also necessary to re-designate a numerical value every time the angle of view of the camera changes. Therefore, in the second embodiment, an example in which various (e.g., not only circular but also rectangular) task regions can be set, and numerical values (e.g., coordinates) obtained by object detection or the like can further be designated, rather than just a setting method in which numerical values are designated, will be described.

The hardware configuration of the system 100 according to the second embodiment and the configuration of the main screen 400 are similar to those in FIGS. 1 and 4 of the first embodiment.

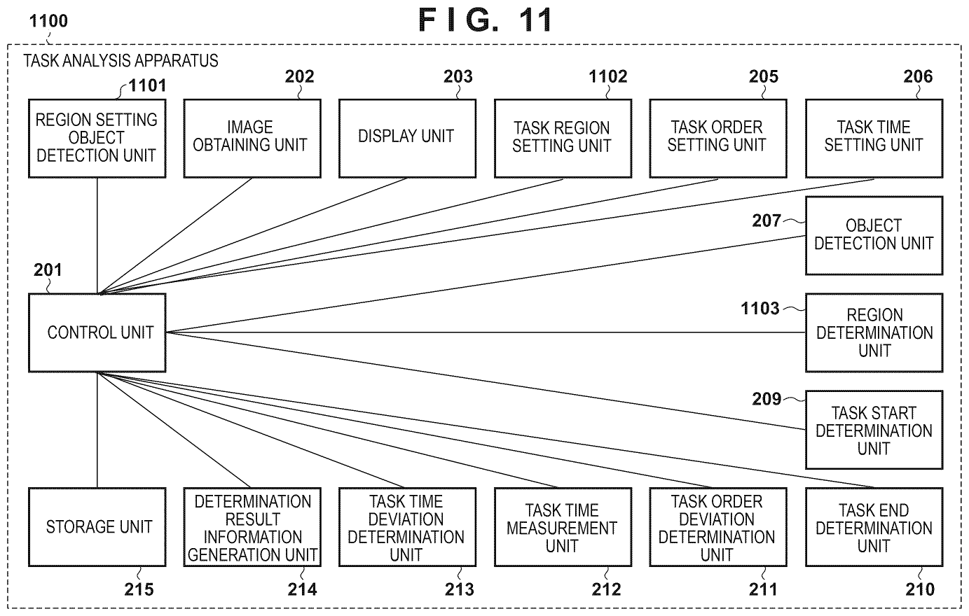

FIG. 11 is a block diagram illustrating a configuration of a task analysis apparatus that realizes functions of the system 100 according to the second embodiment.

A task analysis apparatus 1100 of the present embodiment includes a region setting object detection unit 1101, and the functions of the task region setting unit 1102 and a region determination unit 1103 differ.

The region setting object detection unit 1101 detects an object in the captured image and obtains detected object information and coordinate information (e.g., vertex coordinates and center coordinates of a rectangle circumscribing the object in the image). The region setting object detection unit 1101 detects an arbitrary object by various object detection methods similarly to the object detection unit 207. The object detection unit 1101 detects an object set in a region setting object text box 1221, which will be described later. The object to be detected and the object detection method of the present embodiment are similar to those of the object detection unit 207 of the first embodiment.

The task region setting unit 1102 sets one or more task regions in which task analysis is to be performed based on the object detection result of the region setting object detection unit 1101.

The region determination unit 1103 determines whether an object is detected in the task region set by the task region setting unit 1102 based on the task region information set by the task region setting unit 1102 and the object detection result obtained by the object detection unit 207.

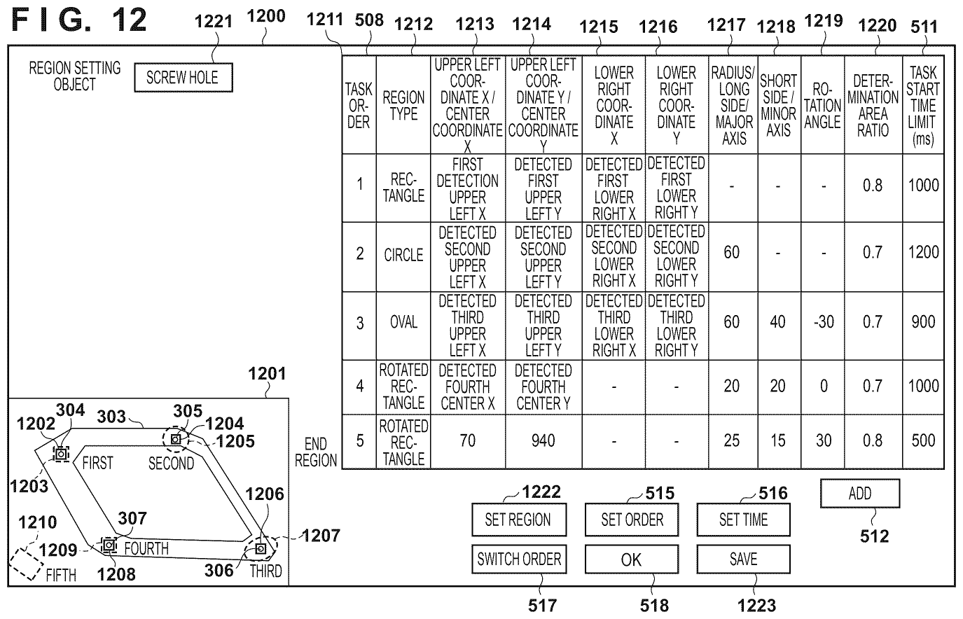

FIG. 12 is an example of a setting screen 1200 displayed by operation of the setting button 411 of the main screen 400 of FIG. 4. The setting screen 1200 is displayed by the control unit 201 controlling the display unit 203. A captured image 1201 captured in advance by the image capture device 108 and stored in the storage unit 215 is displayed in the setting screen 1200. The setting screen 1200 also includes setting information 1211 (which is a set information list), the add button 513, the region setting object text box 1221, a region setting button 1222, the order setting button 515, the time setting button 516, the order switch button 517, the OK button 518, and a save button 1223.

The screw holes 304, 305, 306, and 307 of the task target object 303 are captured in the captured image 1201. Further, a task region 1203, which corresponds to the screw hole 304, is set and displayed on the captured image 1201. Further, a task region 1205, which corresponds to the screw hole 305, is set and displayed on the captured image 1201. Further, a task region 1207, which corresponds to the screw hole 306, is set and displayed on the captured image 1201. Further, a task region 1209, which corresponds to the screw hole 307, is set and displayed on the captured image 1201. Further, a task region 1210, which corresponds to a task end position, is set and displayed on the captured image 1201. Further, the detection rectangles 1202, 1204, 1206, and 1208 of the screw holes detected by the region setting object detection unit 1101 are displayed on the captured image 1201.

The task regions 1203, 1205, 1207, 1209, and 1210 are generated based on setting values of the task order 508, a region type 1212, an upper left coordinate X/center coordinate X 1213, an upper left coordinate Y/center coordinate Y 1214, a lower right coordinate X 1215, a lower right coordinate Y 1216, a radius/long side/major axis 1217, a short side/minor axis 1218, a rotation angle 1219, and a determination area ratio 1220 of the setting information 1211.

The setting information 1211 includes the task order 508, the region type 1212, the upper left coordinate X/center coordinate X 1213, the upper left coordinate Y/center coordinate Y 1214, the lower right coordinate X 1215, the lower right coordinate Y 1216, the radius/long side/major axis 1217, the short side/minor axis 1218, the rotation angle 1219, and the determination area ratio 1220, which are task region information, and the task start time limit (ms) 512, which is task time information.

Regarding the region setting object text box 1221, region setting object information is set by the user directly inputting text of the type of an object to be detected.

The region setting button 1222 sets the region type 1212, the upper left coordinate X/center coordinate X 1213, the upper left coordinate Y/center coordinate Y 1214, the lower right coordinate X 1215, the lower right coordinate Y 1216, the radius/long side/major axis 1217, the short side/minor axis 1218, the rotation angle 1219, and the determination area ratio 1220 of a record selected in advance in the setting information 1211 by being operated by the user.

The region type 1212 indicates the set region type. In the present embodiment, regarding the region type, an arbitrary type of region is set from among “rectangle”, “rotated rectangle”, “circle”, and “oval”. In addition to the above example, it may be made possible to set a free shape as a region by operating a GUI using a mouse or the like. The region setting object detection unit 1101 may be capable of setting a region of an arbitrary object that can be obtained by a method such as semantic segmentation.

The upper left coordinate X/center coordinate X 1213, the upper left coordinate Y/center coordinate Y 1214, the lower right coordinate X 1215, the lower right coordinate Y 1216, the radius/long side/major axis 1217, the short side/minor axis 1218, and the rotation angle 1219 are set based on the type of region set in the region type 1212.

When the region type 1212 is a “rectangle”, the upper left coordinate X/center coordinate X 1213 and the upper left coordinate Y/center coordinate Y 1214 are set as the upper left coordinate values of the rectangle. In addition, the lower right coordinate X 1215 and the lower right coordinate Y 1216 are set as the lower right coordinate values of the rectangle. Then, a task region is generated based on these setting values.

When the region type 1212 is a “rotated rectangle”, the upper left coordinate X/center coordinate X 1213 and the upper left coordinate Y/center coordinate Y 1214 are set as the center coordinate values of the rectangle. In addition, the radius/long side/major axis 1217 is set as the length of the long side of the rectangle. In addition, the short side/minor axis 1218 is set as the length of the short side of the rectangle. In addition, the rotation angle 1219 is set as a numerical value of the rotation angle of the rectangle. Then, a task region is generated based on these setting values.

When the region type 1212 is a “circle”, the upper left coordinate X/center coordinate X 1213 and the upper left coordinate Y/center coordinate Y 1214 are set as center coordinate values of the circle, the radius/long side/major axis 1217 is set as the radius of the circle, and a task region is generated based on these setting values.

When the region type 1212 is an “oval”, the upper left coordinate X/center coordinate X 1213 and the upper left coordinate Y/center coordinate Y 1214 are set as the center coordinate values of the oval. In addition, the radius/long side/major axis 1217 is set as the major axis of the oval. In addition, the short side/minor axis 1218 is set as the minor axis of the oval. Then, a task region is generated based on these setting values.

Further, the upper left coordinate X/center coordinate X 1213, the upper left coordinate Y/center coordinate Y 1214, the lower right coordinate X 1215, the lower right coordinate Y 1216, the radius/long side/major axis 1217, the short side/minor axis 1218, and the rotation angle 1219 may be set by values being directly inputted into corresponding fields. Further, respective setting values may be set by a GUI operation using a mouse or the like on the captured image 1201 or may be set using an object detection result. In the example of FIG. 12, a rectangle is selected as the region type 1212 in a record set to “1” in the task order 508, for example. The upper left coordinate X/center coordinate X 1213, the upper left coordinate Y/center coordinate Y 1214, the lower right coordinate X 1215, and the lower right coordinate Y 1216 are respectively set to the upper left X coordinate value, the upper left Y coordinate value, the upper right X coordinate value, and the upper right Y coordinate value of the first detected detection result among the detection results detected by the region setting object detection unit 1101, based on the type of the object inputted in the region setting object text box 1221. In addition to the above example, arbitrary coordinate values of an object detection result may be set, such as the X coordinate value and the Y coordinate value of the center of the detected object.

The determination area ratio 1220 is set as a threshold for determining whether an object is present in the task region, and is set by a value being directly inputted into a corresponding field by being operated by the user.

The OK button 518 is an operation button for ending region setting by being operated by the user.

The save button 1223 is an operation button for storing the setting information 1211 and the region setting object information inputted into the region setting object text box 1221 in the storage unit 215 and ending the processing of the setting screen 500 by being operated by the user.

FIG. 13 is a flowchart illustrating control processing of the system 100 according to the present embodiment.

In FIG. 13, processing similar to that of FIG. 6 will be assigned the same step numerals and description will be omitted.

In step S1301, the control unit 201 controls the region setting object detection unit 1101 to detect an object from the captured image obtained in step S601 based on the region setting object information stored in the storage unit 215. The control unit 201 also obtains object information detected by the region setting object detection unit 1101, the vertex coordinates of a rectangle circumscribing the object in the captured image, and the like.

In step S1302, the control unit 201 controls the task region setting unit 1102 to set a task region based on the setting information stored in the storage unit 215 and the object detection result obtained in step S1301.

In step S1303, the control unit 201 controls the region determination unit 1103 to determine whether an object is present in the task region based on the setting information stored in the storage unit 215, the task region information set in step S1302, and the coordinate information of an object obtained in step S604. The control unit 201 obtains the determination result and the order value of the determination target task region. The determination as to whether an object is present in the task region is performed by determining whether a region in which a region obtained from the coordinate information of the object obtained in step S604 overlaps with a respective task region set in step S1302 is greater than or equal to a determination area ratio set for a respective position in the task order, as in Equation 2 below.

$$\{ \begin{matrix}an object is present in a task region … {Th}_{i} \geq \frac{{Area}_{i \_ ob}}{{Area}_{i}} \\ an object is not present in a task region … {Th}_{i} < \frac{{Area}_{i \_ ob}}{{Area}_{i}}\end{matrix} \qquad ( Equation 2 )$$

In Equation 2, Thi corresponds to a determination area ratio for the i-th position in the task order set in the setting information. Areai_ob indicates a surface area of a region in which the task region set in the i-th position in the task order overlaps with a region obtained from the coordinate information of the object obtained in step S604. Areai indicates a surface area of a task region set in the i-th position in the task order. As in Equation 2, if the surface area of a region in which the task region set in the i-th position in the task order overlaps with a region obtained from the coordinate information of the object obtained in step S604 is greater than or equal to the determination area ratio, it is determined that an object is present in the task region. In addition, if it is smaller than the determination area ratio, it is determined that no object is present in the task region. The determination as to whether an object is present in the task region is not limited to the above example, and for example, it may be determined that an object is present in the region based on whether a region in which a detected object and the task region are overlapped is greater than or equal to a threshold with respect to a region obtained from the coordinate information of the detected object may be performed.

As described above, according to the second embodiment, in addition to the effects of the first embodiment, the shape of a task region can be set to various (e.g., not only circular but also rectangular) shapes and can also be set using numerical values (e.g., coordinates) obtained by object detection or the like, not just designating numerical values.

### Third Embodiment

Next, a third embodiment will be described.

In the following, descriptions in common with the first embodiment will be omitted, and parts different from the first embodiment will be described.

In the first embodiment, a method in which the region determination unit 208 calculates center coordinates from the coordinate information of an object obtained by the object detection unit 207 and determines whether the center coordinates of the object are included in each respective task region has been described. In detailed tasks in which hands are used, for example, it is necessary to determine whether an object is present in a task region using not only coordinate information of the object but also detailed coordinate information such as that of a fingertip of a worker's hand. Therefore, in the present embodiment, an example in which an orientation estimation unit 1401 can obtain the orientation information of an object in a captured image for the object detected by the object detection unit 207 will be described.

The hardware configuration of the system 100 according to the third embodiment and the configuration of the main screen 400 are similar to those in FIGS. 1 and 4 of the first embodiment.

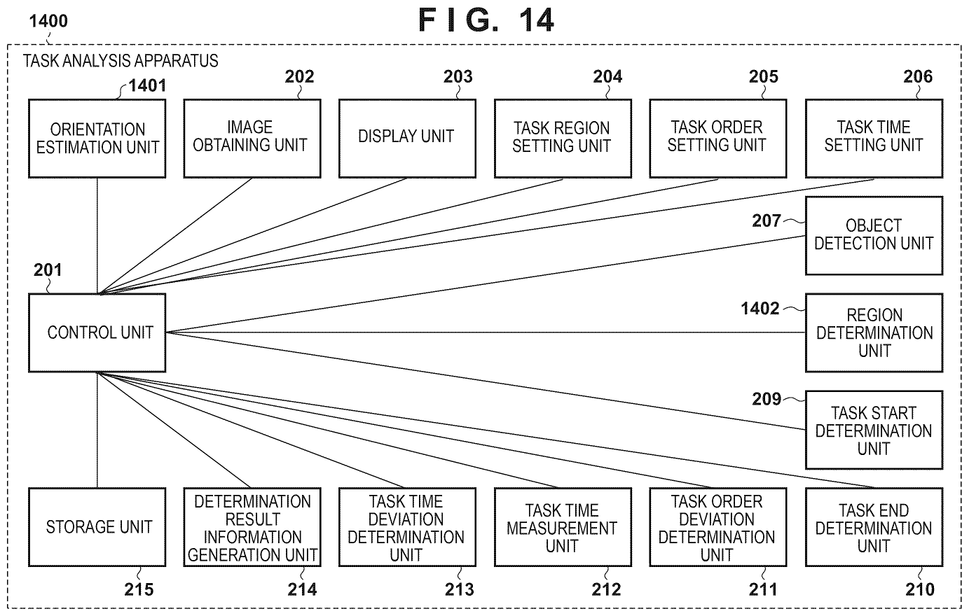

FIG. 14 is a block diagram illustrating a configuration of a task analysis apparatus that realizes functions of the system 100 according to the third embodiment.

A task analysis apparatus 1400 of the present embodiment includes the orientation estimation unit 1401 and the functions of a region determination unit 1402 differ.

The orientation estimation unit 1401 obtains coordinate information of a joint point of an object in the image for the object detected by the object detection unit 207. For example, in the present embodiment, the orientation estimation unit 1401 obtains the coordinate information of a joint point of a tool using an orientation estimation model that has been trained to estimate in advance the positions of a plurality of joint points such as a tip point, a center point, and an end point of the tool from the image.

The region determination unit 1402 determines whether an object has been detected in a task region set by the task region setting unit 204 based on an orientation estimation result obtained by the orientation estimation unit 1401.

FIG. 15 is a flowchart illustrating control processing of the system 100 according to the present embodiment.

In FIG. 15, processing similar to that of FIG. 6 will be assigned the same step numerals and description will be omitted.

In step S1501, the control unit 201 controls the orientation estimation unit 1401 to obtain joint point coordinates of the object detected in step S604 in the captured image obtained in step S601.

In step S1502, the control unit 201 controls the region determination unit 1402 to compare the setting information stored in the storage unit 215 and the joint point coordinates of the object obtained in step S1501 and determines whether the object is present in the task region. Then, the control unit 201 obtains the determination result and the order value of the determination target task region. Regarding the determination as to whether an object is present in the task region in the present embodiment, it is determined whether the object is included in each respective region by calculating a distance between the joint point coordinates of the object obtained in step S1501 and the center coordinates of the respective region as in Equation 3 below.

$$\{ \begin{matrix}an object is present in a task region … {r}_{i} \geq \sqrt{{( KX - Cxi )}^{2} + {( KY - Cyi )}^{2}} \\ an object is not present in a task region … {r}_{i} < \sqrt{{( KX - Cxi )}^{2} + {( KY - Cyi )}^{2}}\end{matrix} \qquad ( Equation 3 )$$

In Equation 3, KX corresponds to the X coordinate of the joint point coordinates of the object obtained in step S1501. KY corresponds to the Y coordinate of the joint point coordinates of the object. Cxi corresponds to a center coordinate X for the i-th position in the task order set in the setting information. Cyi corresponds to the center coordinate Y for the i-th position in the task order. ri corresponds to the radius for the i-th position in the task order. As in Equation 3, if a distance between the joint point coordinates of the object and the center coordinates of each respective task region set in the setting information is less than or equal to the radius of the respective task region, it is determined that an object is present in the task region, and if the distance is greater than the radius, it is determined that no object is present in the task region. In addition, regarding the obtained order value, if it is determined that an object is present in an i-th task region in the task order, “i”, which is its position in the task order, is obtained, and if it is determined that no object is present in any of the task regions, “0” is obtained. Further, these values may be set to arbitrary values, and for example, whether an object is present in a region may be determined by selecting arbitrary joint point coordinates among the joint point coordinates of the object. Further, a configuration may be taken so as to select a plurality of joint point coordinates from among the joint point coordinates of an object and determine whether each is within a region.

As described above, according to the third embodiment, in addition to the effects of the first embodiment, it is possible to determine whether an object is present in a task region using not only coordinate information of the object but also detailed coordinate information such as a joint point of the object.

According to the present disclosure, it is possible to easily determine that a task has ended even when an object is repeatedly detected and undetected in a given task region.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-169200, filed Sep. 27, 2024 which is hereby incorporated by reference herein in its entirety.

What is claimed is:

1. A task analysis apparatus that determines whether tasks have been performed in a predetermined task process, the apparatus comprising:
a region setting unit that sets, in an image in which a task state has been captured, a plurality of task regions for which task analysis is to be performed;
an order setting unit that sets, for the plurality of task regions, an order in which tasks are to be performed;
an object detection unit that detects an object in the image; and
a determination unit that
in response to the object being detected in a predetermined task region, determines that a task has been started in the predetermined task region, and
in response to the object being detected in a task region that is next in order after the predetermined task region, determines that the task has ended in the predetermined task region.

2. The apparatus according to claim 1, further comprising:
a region determination unit that determines, based on a detection result of the object detection unit, whether an object has been detected in a task region set by the region setting unit.

3. The apparatus according to claim 2, further comprising:
a task order deviation determination unit that determines, based on a task region in which it is determined that an object is present by the region determination unit and a task region in which it is determined that a task has been started, whether the order of tasks set by the order setting unit has been deviated from.

4. The apparatus according to claim 3, wherein
in a case where after it is determined that a task has been started in the predetermined task region, the order of tasks set by the order setting unit has not been deviated from, the determination unit determines, in response to the object being detected in the task region that is next in order after the predetermined task region, that the task has ended in the predetermined task region.

5. The apparatus according to claim 3, wherein
in a case where a position of a task of a task region, for which it is determined that the object is present by the region determination unit, in the order is equal to a position of a task of a last task region in the order, the determination unit determines that tasks of all task regions have ended.

6. The apparatus according to claim 2, wherein
in a case where a position of a task of a task region, for which it is determined that the object is present by the region determination unit, in the order is different from a position of a task of a task region, in which it is determined that the task has been started, in the order, the determination unit determines that the task of the task region for which it is determined that the object is present has been started.

7. The apparatus according to claim 6, further comprising:
a task time setting unit that sets a task time for each task region set by the region setting unit;
a task time measurement unit that measures the task time for each task region; and
a task time deviation determination unit that determines whether the task time measured by the task time measurement unit is within a time limit set by the task time setting unit.

8. The apparatus according to claim 7, further comprising:
a unit that generates and displays determination result information including a position of a task in the order, a determination result of a start or end of the task, a deviation determination result of the position of the task in the order, a deviation determination result of the task time, and the task time, for each task region; and
a storage unit that stores the image, coordinate information of the object, coordinate information of the task regions, the order of tasks, the determination result of the start or end of the task, the deviation determination result of the position of the task in the order, the deviation determination result of the task time.

9. The apparatus according to claim 1, wherein
the object detection unit detects an object by using a learning model trained in advance so as to obtain coordinate information of an object in the image.

10. The apparatus according to claim 1, wherein
the object detection unit detects an object by using a learning model trained in advance to detect a feature of an object in the image, detects an object by using feature matching of an object in the image, detects a two-dimensional code as an object, or detects an object by a method of detecting a region for each object occupying an image.

11. The apparatus according to claim 1, wherein
the region setting unit is capable of setting shapes of the task regions.

12. The apparatus according to claim 1, wherein
the region setting unit is capable of setting the shapes of the task regions by using coordinate information of an object detected in the image.

13. The apparatus according to claim 2, wherein
the region determination unit determines that an object is present in the task region by a distance between coordinate information of the object detected by the object detection unit and a center of the task region set by the region setting unit falling within a threshold.

14. The apparatus according to claim 2, wherein
the region determination unit determines that an object is present in the task region by an area ratio of an overlap between a region obtained based on coordinate information of the object detected by the object detection unit and the task region set by the region setting unit being greater than or equal to a threshold.

15. The apparatus according to claim 2, wherein
the region determination unit determines that the object is present in the task region by a distance between coordinate information of one or more joint points among pieces of orientation information of the object detected by the object detection unit and a center of the task region set by the region setting unit falling within a threshold.

16. A task analysis method of determining whether tasks have been performed in a predetermined task process, the method comprising:
setting, in an image in which a task state has been captured, a plurality of task regions for which task analysis is to be performed;
setting, for the plurality of task regions, an order in which tasks are to be performed;
detecting an object in the image;
in response to the object being detected in a predetermined task region, determining that a task has been started in the predetermined task region, and
in response to the object being detected in a task region that is next in order after the predetermined task region, determining that the task has ended in the predetermined task region.

17. A non-transitory computer-readable storage medium storing a program for causing a computer to function as a task analysis apparatus that determines whether tasks have been performed in a predetermined task process, the apparatus comprising:
a region setting unit that sets, in an image in which a task state has been captured, a plurality of task regions for which task analysis is to be performed;
an order setting unit that sets, for the plurality of task regions, an order in which tasks are to be performed;
an object detection unit that detects an object in the image; and
a determination unit that
in response to the object being detected in a predetermined task region, determines that a task has been started in the predetermined task region, and
in response to the object being detected in a task region that is next in order after the predetermined task region, determines that the task has ended in the predetermined task region.

18. A system including:
a task analysis apparatus;
an image capture apparatus that captures the image; and
an output apparatus that outputs information on a result of determination by the task analysis apparatus in a superimposed manner on the image,
wherein the task analysis apparatus determines whether tasks have been performed in a predetermined task process, and comprises
a region setting unit that sets, in an image in which a task state has been captured, a plurality of task regions for which task analysis is to be performed;
an order setting unit that sets, for the plurality of task regions, an order in which tasks are to be performed;
an object detection unit that detects an object in the image; and
a determination unit that
in response to the object being detected in a predetermined task region, determines that a task has been started in the predetermined task region, and
in response to the object being detected in a task region that is next in order after the predetermined task region, determines that the task has ended in the predetermined task region.
